(19) United States
(12) Patent Application Publication
(10) Pub. No.: US 2005/0270386 A1
(43) Pub. Date: Dec. 8, 2005

(54) Method and apparatus for authentication utilizing iris

(76) Inventors: Hirofumi Saitoh, Ogaki-City (JP); Keisuke Watanabe, Mizuho-City (JP); Kohji Matsumura, Gifu-City (JP); Tatsushi Ohyama, Ogaki-City (JP)

Correspondence Address: MCDERMOTT WILL & EMERY LLP, 600 13TH STREET, N.W., WASHINGTON, DC, 20005-3096, US

(21) Appl. No.: 11/139,022

(22) Filed: May 27, 2005

(30) Foreign Application Priority Data
May 28, 2004 (JP) 2004-159022

(51) Int. Cl. H04N 5/262

(52) U.S. Cl. 348/239

(57) ABSTRACT

A first image pickup unit mainly captures the image of whole face. A second image pickup unit mainly captures an image of iris in an eye. A display unit simultaneously displays both an image picked up by the first image pickup unit and an image picked up by the second image pickup unit on divided display regions, and naturally prompts a user to operate in such manner as to include himself/herself within an image pickup range. When the user moves his/her face or an authentication apparatus upon seeing this display, a relative position or direction of the iris and the image pickup device can be set to a desired state.

### BACKGROUND OF THE INVENTION

1. Field of the Invention

The present invention relates to method and apparatus for authentication, and it particularly relates to method and apparatus for carrying out authentication by matching registered iris data with data of iris captured at the time of authentication.

2. Description of the Related Art

Along with the advance of a highly information-oriented society, there is a growing demand for the protection of personal information. One of various attempts to meet the demand is the use of biometric authentication, which can foil forgery or impersonation far more effectively than such methods as entry of a password. Of such authentication techniques, one attracting much attention today is a technique using the iris in our eye. The iris little changes over the course of a person's life and moreover allows non-contact authentication. The “iris”, which is a doughnut-shaped part around the pupil, has a wrinkle pattern peculiar to each individual, thus realizing highly accurate personal identification.

Reference (1) listed in the following Related Art List discloses a technique for matching iris data provided at authentication with iris data already registered.

Related Art List

(1) Japanese Published Patent Application No. Hei08-504979.

For a successful comparison, or matching, in a technique as disclosed in Reference (1), however, both the registered iris data and the iris data to be picked up at authentication must have a level of quality that supports and then realizes matching. For example, a matching cannot be achieved with accuracy if the iris is not properly within an image picked up or if there is a large difference in orientation of the iris pattern between registration and authentication. Such a tendency toward unsuccessful authentication will be magnified especially when the authentication device is a mobile-device whose image pickup unit does not have a fixed viewpoint.

### SUMMARY OF THE INVENTION

The present invention has been made in view of the foregoing circumstances and problems and an object thereof is to provide an authentication technique and an authentication apparatus capable of easily acquiring iris data with a level of quality that supports and realizes matching.

In order to solve the above problems, a method according to a preferred mode of carrying out the present invention is a method in which authentication is carried out by matching registered iris data with iris data obtained from images picked up at the time of authentication, the method being characterized in that a reference position of an iris is determined using a face image and an iris image. It is to be noted here that the “face image” may include an image covering the entire face or an image in which part of the face is missing and it may also include an image to the extent that the both eyes are covered. The “iris image” may include not only an image showing an iris having resolution to the extent that the patterns of iris can be identified, but also images captured during a process of shooting such images of iris. The “reference position” may include a reference position within a display image for guiding a user and a reference position on the coordinates.

According to this mode of carrying out the present invention, the positional relationship between the face and the iris is considered utilizing the face image, so that the positioning of an iris within the iris image can be easily carried out.

Another preferred mode of carrying out the present invention relates also to an authentication method. This authentication method matches registered iris data with iris data obtained from images picked up at the time of authentication, and the method is characterized in that an iris' angle of rotation from a predetermined reference pattern is identified using a face image and an iris image. Here, the angle of rotation may be identified based on a relative position of a marked-out position on the face image and a marked-out position of the iris image. The “predetermined reference pattern” may include a horizontal axis on the coordinates, an axis joining corners of eye on the registered iris pattern and so forth.

According to this mode of carrying out the present invention, the iris' angle of rotation from an object to be compared can be obtained by considering the positional relationship between the face and the iris. If iris data is corrected with this angle of rotation, the comparable data can be easily produced.

Still another preferred mode of carrying out the present invention relates to an authentication apparatus. This authentication apparatus carries out authentication by matching registered iris data with iris data obtained from images picked up at the time of authentication, and the apparatus comprises: a first image pickup unit which picks up a face image; and a second image pickup unit which picks up an iris image. A reference position of an iris is determined using the face image and the iris image.

According to this mode of carrying out the present invention, the positional relationship between the face and the iris is considered utilizing the face image, so that the positioning of an iris within the iris image can be easily carried out. Furthermore, a plurality of image pickup units are provided, so that there is no longer needed an image pickup device capable of capturing face image having a level of resolution with which the iris pattern is identifiable. Thus, the image pickup unit can be furnished with lower cost.

Still another preferred mode of carrying out the present invention relates also to an authentication apparatus. This authentication apparatus carries out authentication by matching registered iris data with iris data obtained from images picked up at the time of authentication, and the apparatus comprises: a first image pickup unit which picks up a face image; and a second image pickup unit which picks up an iris image, wherein an iris' angle of rotation from a predetermined reference pattern is identified using the face image and the iris image.

The apparatus may further comprise a display unit which displays an image inputted from the first image pickup unit and an image inputted from the second image pickup unit in such a manner as to move the iris to a predetermined position on the image inputted from the second image pickup unit, and the apparatus may further comprise a display unit which displays an image inputted from the first image pickup unit and a predetermined guide in such a manner as to move the iris to a predetermined position on the image inputted from the second image pickup unit. With the provision of such a display unit as this, the user can be prompted so that the iris is captured and shown in a predetermined position of the iris image.

Still another preferred mode of carrying out the present invention relates to a portable device. This portable device is equipped with an authentication apparatus described above and permits a user, whose identification by the authentication apparatus has been approved, to use the portable device. It is preferable that first image pickup unit and the second image pickup unit be mounted on a casing so that a distance between mounting locations of the first image pickup unit and the second image pickup unit is practically maximum.

According to this mode of carrying out the present invention, the iris data whose level can support and realize the matching can be easily obtained, so that highly accurate authentication can be realized even when an iris authenticating function is incorporated into a portable device. Furthermore, if the device is provided with a plurality of image pickup units where they are separated distant apart from one another, highly accurate three-dimensional information can be obtained.

It is to be noted that any arbitrary combination of the above-described structural components as well as the expressions according to the present invention changed among a method, an apparatus, a system, a recording medium, a computer program and so forth are all effective as and encompassed by the present embodiments.

### BRIEF DESCRIPTION OF THE DRAWINGS

FIG. 1 illustrates a first example of a mobile device according to a first embodiment of the present invention.

FIG. 2 is a diagram showing function blocks of an authentication apparatus according to a first embodiment of the present invention.

FIGS. 3A and 3B each illustrate a face image inputted from a first image pickup unit and an iris image inputted from a second image pickup unit, of which FIG. 3A shows images at the registration of an iris pattern and FIG. 3B shows images at authentication.

FIG. 4 illustrates a second example of a mobile device according to the first embodiment.

FIG. 5 illustrates another example of display of a second example of a mobile device.

FIG. 6 illustrates a third example of a mobile device according to the first embodiment.

FIG. 7 illustrates how a face image and an iris image of a user are picked up by a mobile device shown in FIG. 6.

FIG. 8 is a diagram showing function blocks of an authentication apparatus according to a second embodiment of the present invention.

FIGS. 9A and 9B illustrate how a template is produced in a manner that an image in close proximity of an eye of face is extracted in a lattice shape. FIG. 9A shows a case when the image taken is the iris; and FIG. 9B shows a case when the image taken is not the iris.

FIG. 10 illustrates how a template is produced while various processings are performed on image data acquired.

FIG. 11 illustrates how the image data in an image buffer is corrected in a rhombus shape.

FIGS. 12A and 12B illustrate how matching processings are carried out sequentially by executing various processings for each memory row of an iris image. FIG. 12A illustrates how a template covering the whole iris image is matched; and FIG. 12B illustrates how a template covering part of an iris image is matched.

FIGS. 13A to 13C illustrate how iris image data are weighted. FIG. 13A shows how the iris image data are weighted for each column; FIG. 13B shows how the iris data are weighted for each row; and FIG. 13C shows how the iris data are weighted for each row and column.

FIG. 14 illustrates a process in which the displacement of iris angle is getting corrected.

FIG. 15 shows an image of iris as well as an image near the iris.

FIGS. 16A and 16B show the entire image of eye. 16B FIG. 16A shows an image of eye with cilia; and FIG. 16B shows an image of eye without cilia.

FIG. 17 is a flowchart showing an example of matching using a database classified based on whether the eye has a single-edged eyelid or not.

FIG. 18 illustrates how a reference is determined utilizing an image of eye.

### DETAILED DESCRIPTION OF THE INVENTION

The invention will now be described based on the following embodiments which do not intend to limit the scope of the present invention but exemplify the invention. All of the features and the combinations thereof described in the embodiments are not necessarily essential to the invention.

### First Embodiment

A first embodiment of the present invention relates to the use of both face image and iris image to easily determine the references, such as coordinates or direction, on an iris in an image picked up.

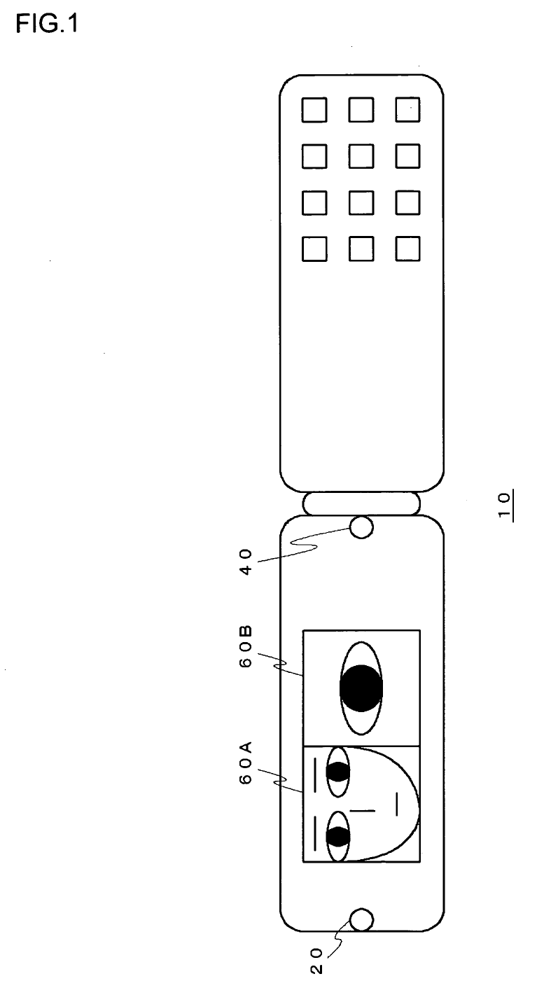

FIG. 1 illustrates a first example of a mobile device according to the first embodiment. The mobile device of FIG. 1 is a first mobile phone 10. The first mobile phone 10 has a structure such that a display-side casing and an operation-side casing are rotatably connected with each other via a hinge member. The display casing is provided with a first image pickup unit 20, a second image pickup unit 40 and a display unit 60.

The first image pickup unit 20, which uses a visible light camera, mainly takes an image of a whole face. The second image pickup unit 40, which uses a high-definition infrared camera, mainly takes an image of an iris in the eye.

The display unit 60, for which an LCD (liquid crystal display), an organic EL (electroluminescent) display or the like is used, displays simultaneously an image inputted from the first image pickup unit 20 and an image inputted from the second image pickup unit 40 in their respective areas dividing the display region. In the display unit 60 as illustrated in FIG. 1, an image inputted from the first image pickup unit 20 is displayed in a left display region 60A, and an image inputted from the second image pickup unit 40 in a right display region 60B.

To be more precise, the display unit 60 displays a face image in the left display region 60A and an iris image in the right display region 60B simultaneously. It is so arranged that the user, while watching the face image displayed, is naturally prompted to adjust the relative position and direction of the user's iris and the authentication apparatus picking up the image thereof in such a manner as to ensure the determination of necessary references on the iris image. Since the image pickup range of an iris image pickup camera is normally narrower than that of a face image pickup camera, it is necessary to bring the iris into the image pickup range of an iris image pickup camera. By moving his/her face or the above-mentioned authentication apparatus intuitively while looking at the display of his/her face, the user can bring the relative position and direction of his/her iris and the authentication apparatus into a desired position or direction.

Also, displaying a face image and an iris image picked up by separate cameras, such as a first image pickup unit 20 and a second image pickup unit 40 in FIG. 1, on a single display device, such as a display unit 60 in FIG. 1, obviates the need for a plurality of display devices and readily provides a condition in which the user can check the states of his/her face and iris at the same time.

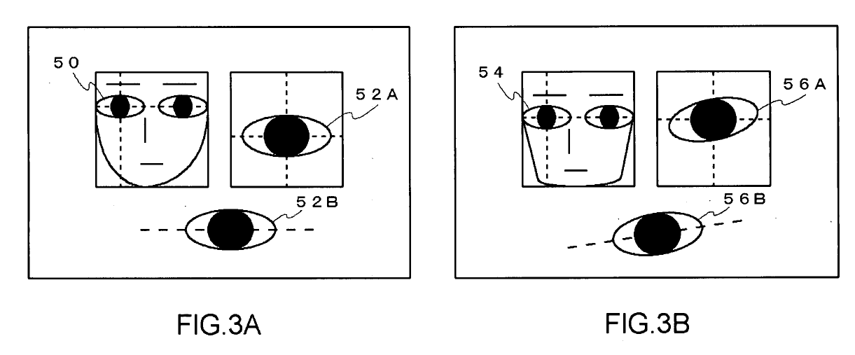

It should be pointed out here that the display unit 60 may be so arranged as to assist the positioning in the horizontal direction by displaying a guide, such as a scale guide as shown in FIG. 3, to be described later, or grid lines in superposition on an iris or iris neighborhood image picked up by the second image pickup unit 40 and a face image picked up by the first image pickup unit 20.

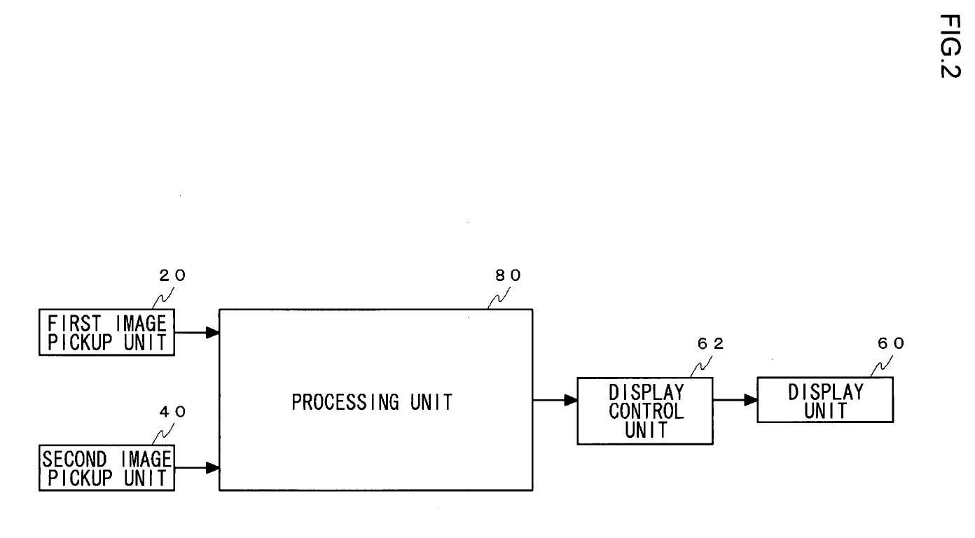

FIG. 2 is a diagram showing function blocks of an authentication apparatus according to the first embodiment of the present invention. In terms of hardware, each block shown here can be realized by a wide variety of elements, such as a processor and a RAM, and a wide variety of devices, such as a camera and a display. In terms of software, it can be realized by a computer program and the like, but drawn and described herein are function blocks that are realized in cooperation with those. Thus, it is understood by those skilled in the art that these function blocks can be realized in a variety of forms such as by hardware only, software only or the combination thereof.

A first image pickup unit 20 and a second image pickup unit 40 output picked-up image data to a processing unit. The processing unit 80 performs various signal processings on the thus inputted image data. In the first embodiment, three-dimensional information, such as the orientation of the iris or the distance to a subject, is calculated using two kinds of image data. A display control unit 62 controls the display mode of images on the display unit 60. For instance, a display control for the aforementioned divided display is performed in consideration of the display region and resolution of the display unit 60. The display unit 60 displays image data according to the instructions from the display control unit 62.

FIGS. 3A and 3B each illustrate a face image inputted from a first image pickup unit 20 and an iris image inputted from a second image pickup unit 40, of which FIG. 3A shows the images at the registration of an iris pattern and FIG. 3B those at authentication. A processing unit 80 acquires a face image from the first image pickup unit 20 and an iris image from the second image pickup unit 40 and determines the orientation of the iris from the relative positional relationship thereof. For example, the orientation, namely, the angle of rotation, of an iris is determined from the relative positional relationship between the eyes in a face image and the center of the pupil in an iris image. However, if a reference position of a face and a pupil center position can be acquired simultaneously by the two image pickup units 20 and 40, then it is not always necessary to display both of the face and the iris.

FIG. 3A represents how a horizontal direction, namely, an angular reference, of an iris pattern is defined at the time of registration. The scale guides in the upper left image are used to recognize in coordinates the position of an eye 50 in an image picked up by the first image pickup unit 20. The scale guides in the upper right image are used to recognize in coordinates the position of an eye 52A in an image picked up by the second image pickup unit 40. Then an iris pattern of an eye 52B, for which the image has been picked up by the second image pickup unit 40 and the horizontal direction has been defined, is registered.

FIG. 3B represents how an angle of rotation from the horizontal direction of an iris pattern is determined from the positional relationship between an eye 54 in an image picked up by the first image pickup unit 20 and an eye 56A in an image picked up by the second image pickup unit 40 at the time of authentication. The angle of rotation from the horizontal direction of a registered iris pattern can be determined from the iris pattern of an eye 56B in an image picked up by the second image pickup unit 40. More specifically, the orientation of an iris can be determined from the positional relationship between a reference position of face in an image picked up by the first image pickup unit 20, for example, a corner of the left eye, and a reference position of an iris in an image picked up by the second image pickup unit 40, for example, the pupil center of the right eye. In particular, the above-mentioned angle of rotation can be determined even when the corner of an eye or the like is not within an image picked up by the second image pickup unit 40. Also, it is possible to take the position of both eyes or the opposite eye in a face image into consideration, thereby raising the accuracy than when determining the said angle of rotation with a single eye.

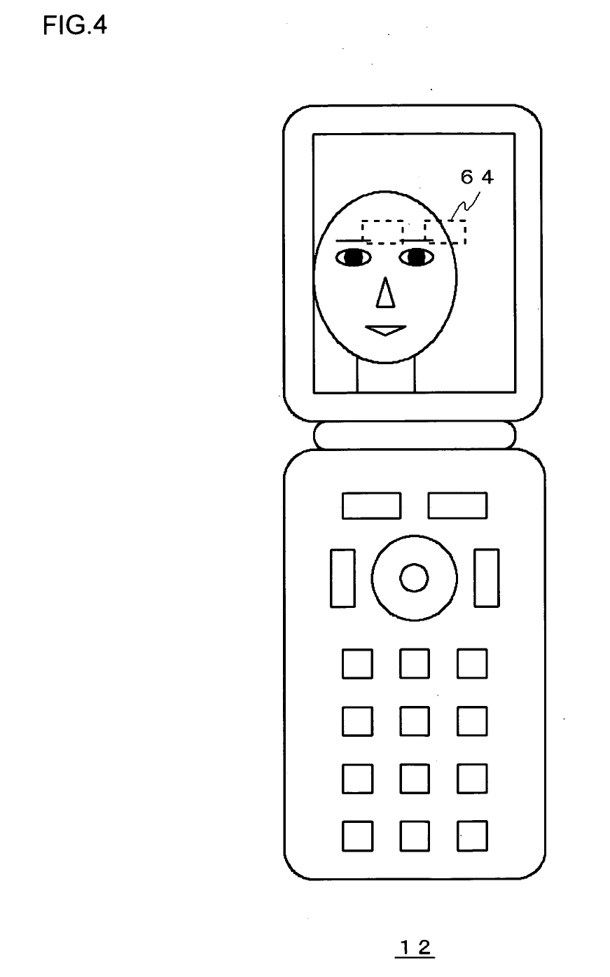

FIG. 4 illustrates a second example of a mobile device according to the first embodiment. The mobile device shown in FIG. 4 is a second mobile phone 12. A display unit 60 of the second mobile phone 12 displays as a guide a frame indicating an image pickup region, or an image pickup possible range, of an iris image pickup unit (not shown) in superposition on a face image picked up by a face image pickup unit (not shown). This arrangement naturally prompts the user to move in such a manner as to enter his/her own iris in the image pickup range of the iris image pickup unit. By moving his/her face or the authentication apparatus intuitively while looking at this display, the user can bring the relative position and direction of his/her iris and the authentication apparatus into a desired position or direction. The user can naturally move the second mobile phone 12 to facilitate the pickup of an iris image in the same manner as he/she moves a hand mirror to reflect the part of his/her face he/she wants to see.

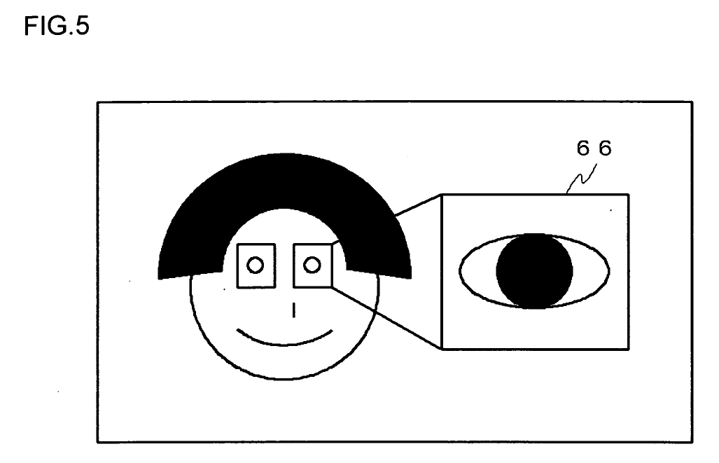

FIG. 5 illustrates another example of display of the second example of a mobile device. In this display example, an image 66 picked up by an iris image pickup unit is displayed within a frame indicating an image pickup possible range on a display unit 60. This picture-in-picture display can prompt the user to adjust the position of the iris and the eyes at the same time.

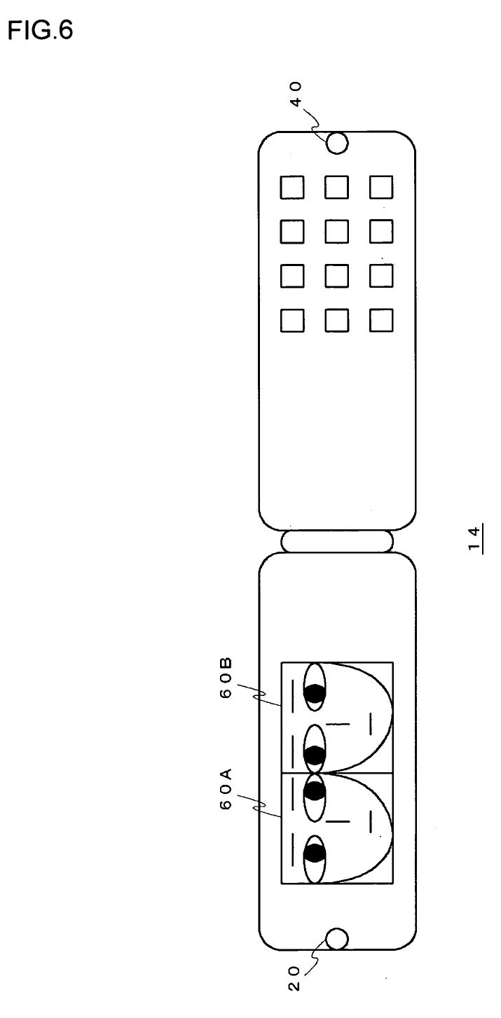

FIG. 6 illustrates a third example of a mobile device according to the first embodiment. The mobile device shown in FIG. 6 is a third mobile phone 14. The third mobile phone 14 differs from the first mobile phone 10 in that the second image pickup unit 40 is provided at the outside end of the operation casing. It is to be noted that in FIG. 6, a face image is shown in the right display region 60B for only the specific purpose of showing that the arrangement of the first image pickup unit 20 and the second image pickup unit 40 as illustrated facilitates the acquisition of parallax images. Basically, therefore, an iris image is displayed in either of the display regions 50A and 50B.

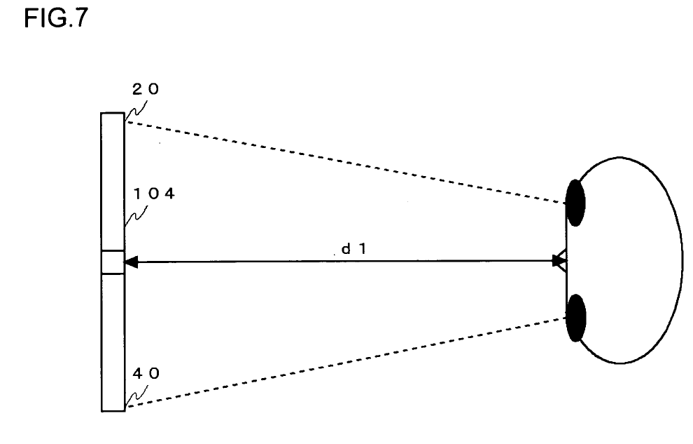

FIG. 7 illustrates how a face image and an iris image of the user are picked up by a mobile device as shown in FIG. 6. As is evident in FIG. 7, images with large parallax can be obtained with a plurality of cameras by disposing the plurality of cameras, a first image pickup unit 20 and a second image pickup unit 40 in this case, at both ends of a device or an integrated part of a device. Hence, it is possible to obtain the distance d1 from the device to the subject and other three-dimensional information efficiently by the use of cameras mounted within a limited space. For example, it is possible to determine the aforementioned orientation of an iris easily by obtaining the inclination of the third mobile phone 14. Also, in a comparison of a picked-up iris image against a registered iris pattern, the acquisition of the above-mentioned distance d1 makes it possible to enlarge or reduce the picked-up iris image to a size appropriate for the comparison. Furthermore, when the above-mentioned distance d1 is too large for a proper recognition of an iris, a message, such as “Please place your eyes closer”, may be displayed to prompt the user to reduce the distance d1.

According to the first embodiment, therefore, it is possible to determine a reference position or direction of an iris easily and accurately by using an image of all or part of a face and an image of an iris. Normally, personal authentication apparatus using zoom function cannot be miniaturized and thus are limited to the gate access use or the like. According to the present embodiment, however, such apparatus or devices can be made smaller and incorporated into mobile devices. Moreover, the authentication apparatus according to the present embodiment is highly convenient without requiring the user to go through the trouble of peeking into a small dedicated image pickup unit.

### Second Embodiment

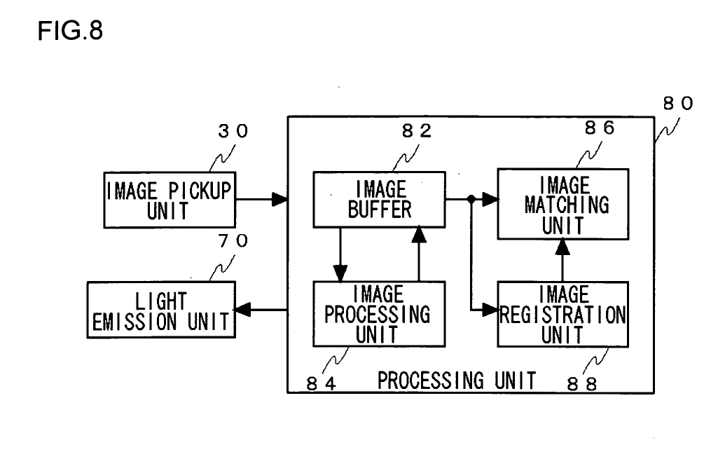

A second embodiment according to the present invention realizes iris authentication with a lower-capacity memory. FIG. 8 is a diagram showing function blocks of an authentication apparatus according to the second embodiment. An image pickup unit 30, in which CCD (Charge Coupled Device) or the like is used to capture images, outputs an iris image as lattice-like image data in units of row, column or plane. The image pickup unit 30 may be a single piece of equipment or structured by a plurality of units as described in the first embodiment. A processing unit 80 includes an image buffer 82, an image processing unit 84, an image matching unit 86 and an image registration unit 88.

The image buffer 32 is a memory area for temporarily storing image data inputted from the image pickup unit 30. In the present embodiment, the image buffer 32 is also utilized as a work area for the image processing unit 84. The image processing unit 84 performs various processes (described later) on image data within the image buffer 82. The image matching unit 86 compares the image data in the image buffer 82 with iris patterns registered in the mage registration unit 88, and then determines whether or not the iris belongs to the same person. The image registration unit 88 registers a template having iris patterns whose images have been taken beforehand.

The light emission unit 70, in which general electric filament lamp, LED (Light Emitting Diode) or the like is used, emits light toward a user when an instruction to do so is given by the processing unit 80. The light emission unit 70 is optional thus may not be actually provided. The detailed description of the light emission unit 70 will be given later.

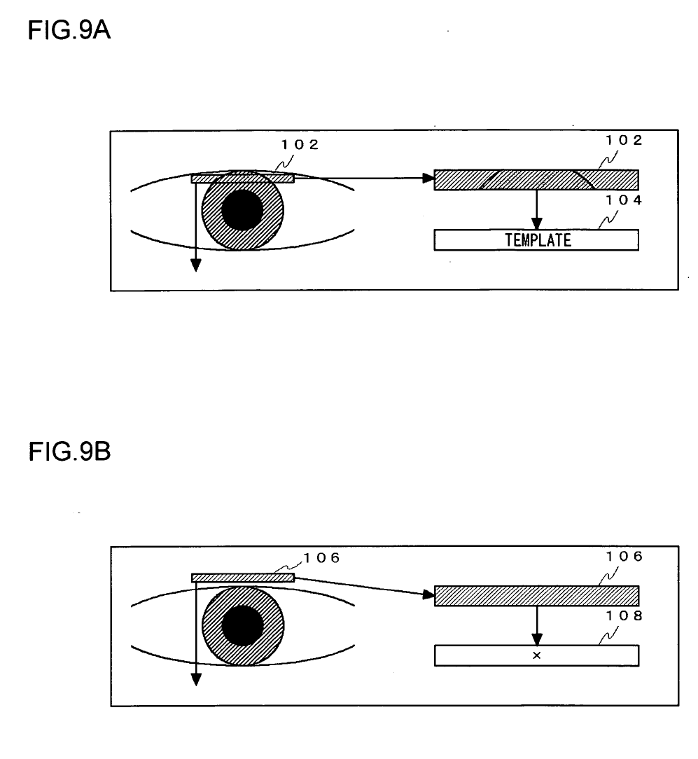

A first operation example of authentication apparatus in the second embodiment is an example where the generation of a template is started when the image pickup unit 30 detects the iris. FIGS. 9A and 9B illustrate how the template is produced in a manner that an image in close proximity of an eye of user's face is extracted in a lattice shape. FIG. 9A shows a case when the image taken is the iris whereas FIG. 9B shows a case when the image taken is not the iris.

Referring to FIG. 9A, the image pickup unit 30 scans an image surrounding an eye of face, from top to the bottom, and then outputs image data 102 of lattice shape to the image buffer 82. When the image processing unit 84 detects, from the image data 102 in the image buffer 82, the iris or some sort of pattern that indicates part surrounding the iris or the like, it starts to create a template 104. In FIG. 9A, the creation of the template 104 is started when a trapezoidal shape is detected at the upper edge of eye. In this manner, the creation of the template 104 can be started before acquiring an image of the whole iris. Then the scanning, the detection of iris and the creation of the template 104 are processed in a pipelined manner. The template created in such a pipeline processing is sent to the image registration unit 88 if registration is being done or sent to the image matching unit 86 if authentication is being done.

Referring to FIG. 9B, when it determines that a template 108 is inappropriate for matching while the template 108 is being created based on an image data 106 in the image buffer 84, the image processing unit 84 discards this template 108 even in the midst thereof and then starts to create a new template. That is, the creation of another template is started before the completion of the current template. Here, the case when it is determined that a template is inappropriate for matching corresponds to the case when no iris is detected at all or no iris is detected from a certain time instance onward.

As described above, in the first operation example, the iris is detected on the real-time basis and the creation of a template is started simultaneously with the detection instated of starting a processing for matching after the whole image is taken in, so that the memory capacity necessary for the image buffer 82 can be reduced. Furthermore, time required up to the matching processing can be reduced. Furthermore, when it is determined during the creation of a template that an image picked up is not the iris or it is determined that the quality or the like of a template under preparation does not satisfy a certain criterion, the creation of the template is stopped and the creation of a new template is started. As a result, the memory capacity therefor can be further reduced and the time necessary for completing the matching can be further reduced.

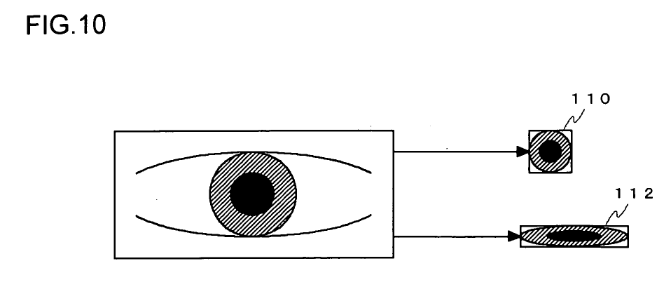

Next, a second operation example of authentication apparatus in the second embodiment is an example where a template is created by processing the image data in real time. FIG. 10 illustrates how the template is produced while various processings are performed on image data acquired.

When obtaining the iris image data, the image processing unit 84 judges the level of quality or the like of the image date, which are being loaded into the image buffer 82 from the image pickup unit 30, and then thins out said image data based on the thus judged level. More specifically, in the middle of generating a template 110 in real time 110, a portion whose quality is determined to be of an inferior quality such as “a portion where data having sufficient image quality cannot be gathered because the iris is hidden behind the eyelashes” or “the image quality of an iris image is low because the light or the like is reflected on the iris” will be thinned out immediately. This can prevent the memory from being occupied by unnecessary data, and can reduce the amount of iris patterns registered in the image registration unit 88. This also allows the matching with a small memory capacity even at the time of authentication.

When the iris image data are gathered, the image processing unit 84 performs an averaging processing on the image data which are being loaded into the image buffer 82 from the image pickup unit 30. More precisely, when there are rows almost overlapping to one another and so forth during the creation of a template 110, the image processing unit 84 performs an averaging procedure or the like on data of a plurality of rows so as to sum them up. The averaging processing or the averaging procedure may be such that two adjacent pixels lying in the vertical direction may be averaged or four adjacent pixels lying in both the vertical and horizontal directions may be averaged. This can compress the image data and can reduce the amount of iris patterns registered in the image registration unit 88. This also allows the matching with a small memory capacity even at the time of authentication. A compression scheme used may be one with no reversibility. In such a case, the compression efficiency can be raised compared with one having the reversibility. The upper template 110 shown in FIG. 10 is a template obtained after processings such as compression, thinning and averaging have been sequentially executed during the loading of image data. The lower template shown in FIG. 10 is a template so generated that the aspect ratio thereof is changed in such a form as to make full use of the iris data.

Next, a third operation example of authentication apparatus in the second embodiment is an example where a template of iris is created in a lattice shape. When gathering the iris image data, the image data are acquired for each horizontal line using an image pickup unit 30, such as CCD, in such a manner as to match the memory arrangement.

The image processing unit 84 divides the iris image data into lattice shapes such as rows and columns. Hence, the creation of a template can be started even if the iris image cannot be acquired through to completion. This can reduce a memory capacity and ensure the high-speed operation.

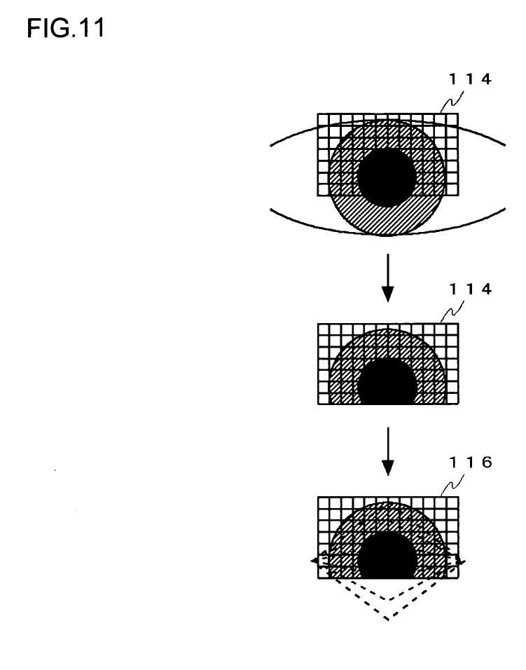

FIG. 11 illustrates how the image data in an image buffer is corrected in a rhomboid shape. The iris image data need to be corrected because the opening of pupil differs per acquisition. The output data from the CCD or the like are acquired in a lattice shape to match a memory arrangement 114 within an image buffer 82. The image processing unit 84 corrects the image data stored in the image buffer 82, using a rhomboid shape. The correction is made in a manner such that the rhomboid is opened if the pupil is open whereas the rhomboid is closed if the pupil is closed. The image data within a memory arrangement 116 after correction, as shown in FIG. 11, are deformed into a rhomboid shape. In this manner, the correcting the image data in a rhomboid shape enables to reduce the calculation amount and the data amount. Furthermore, by correcting the image data in a rhomboid shape instead of correcting them concentrically against distances from the center, the creation of templates can be started earlier since the correction can be made with only part of row or column, for example, if there are some rows covered. Furthermore, even though this is a simple processing, a certain level of high accuracy can be maintained and thus the movement of pupil can be easily tracked and followed up.

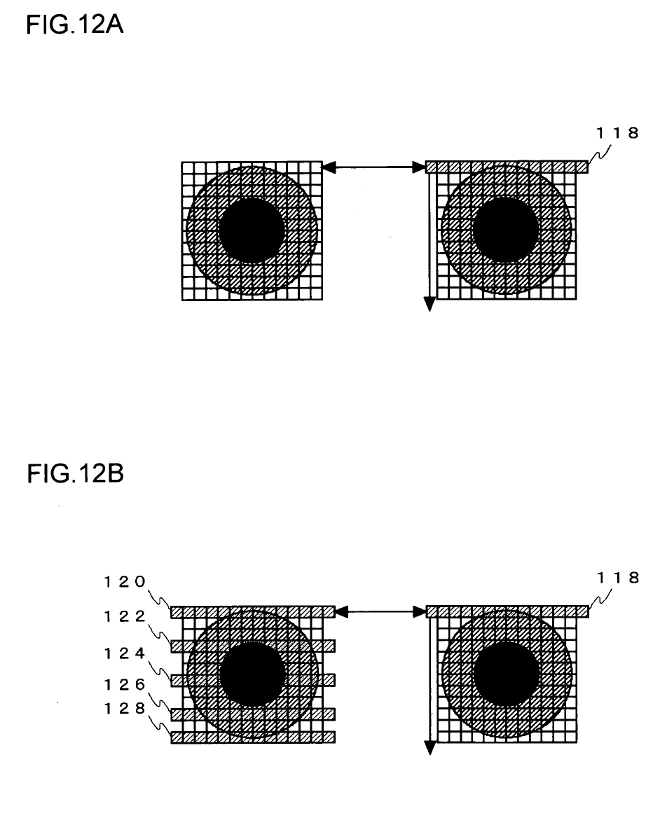

FIGS. 12A and 12B illustrate how matching processings are carried out sequentially by executing various processings for each memory row of an iris image. FIG. 12A illustrates how a template covering the whole iris image is matched whereas FIG. 12B illustrates how a template covering part of an iris image is matched. The left-hand side of FIG. 12A shows a registered iris template whereas the right-hand side thereof shows a lattice-shaped data 118 which are being inputted from the image pickup unit 30. The image matching unit 86 compares and matches for each memory row or column the iris template registered in the image registration unit 88, with the lattice-shaped data 118 being inputted to the image buffer 82, by using various types of matching algorithms such as frequency conversion, Hamming distance, convolutional integration and so forth. This makes it possible to execute matching processings in sequence with an image being scanned, so that the memory amount and the matching time can be reduced. Here, the frequency conversion is a matching method such that a pattern is decomposed into a plurality of frequency components and the weighting factors for the respective frequency components are compared.

The left-hand side of FIG. 12B shows iris templates which are registered in units of lattice shape whereas the right hand-side thereof shows a lattice-shaped data 118 which are being inputted from the image pickup unit 30. In the left-hand side thereof, the shaded areas 120 to 128 only are the templates registered in the image registration unit 88. The image processing unit 84 divides an iris area into a plurality of regions for each of the shaded areas 120 to 128 arranged in line. The image matching unit 86 matches the plurality of regions in each area, and integrates the results in the respective areas so as to determine by using the thus integrated results whether the iris belongs to the valid person. That is, when the data are compared for each row or column, whether the authentication succeeds or fails is determined for each individual row or column, instead of comparing a plurality of rows or columns, and such results are integrated so as to finally determine whether or not the iris belongs to the person in question.

As an example of how to integrate the results, there is a method by which to finally determine that the iris belongs to the identical person if the matching results are positive for a certain fixed number of regions, for example, a certain fixed number of rows. For instance, in FIG. 12B, the authentication can be succeeded if four or more rows are matched among five row templates 120 to 128. Moreover, not only the number of matches but also the sequence of matching or the like may be taken into consideration. In this manner, the scanning is carried out and simultaneously the matching is carried out for each row or for unit column or columns. After the determination is made for rows or columns, the data for those rows or columns become useless, so that the data can be eliminated at once from the memory. As a result, the required memory amount can be made smaller by this amount which can be immediately eliminated. Furthermore, the iris image data to be registered can be made lighter.

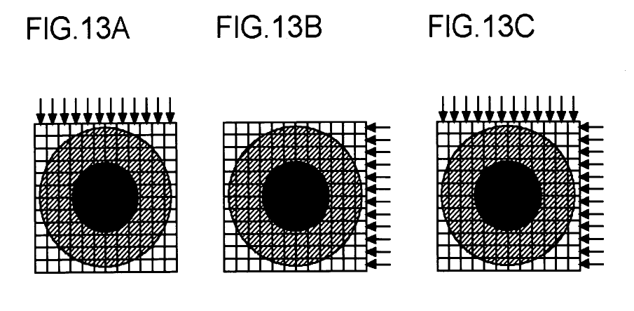

FIGS. 13A to 13C illustrate how iris image data are weighted. FIG. 13A shows how the iris image data are weighted for each column. FIG. 13B shows how the iris data are weighted for each row. FIG. 13C shows how the iris data are weighted for each row and column.

When the integration is to be carried out as described above, the image matching unit 86 weights the data theoretically or empirically, for each and/or column of the iris image data, in accordance with the reliability of the data. Or, the image matching unit 86 deletes the rows or columns of the data, that is, it weights the data with “0”. Examples of such weighting include “A high weight is given to a row where the quality of an image picked up is desirable”, “only the part showing distinguishably the characteristics of a person is given a high weight” and “The weight “0” is given to parts whose images could not be captured because they are covered by eyelid and so forth”. Such weightings can improve the matching accuracy.

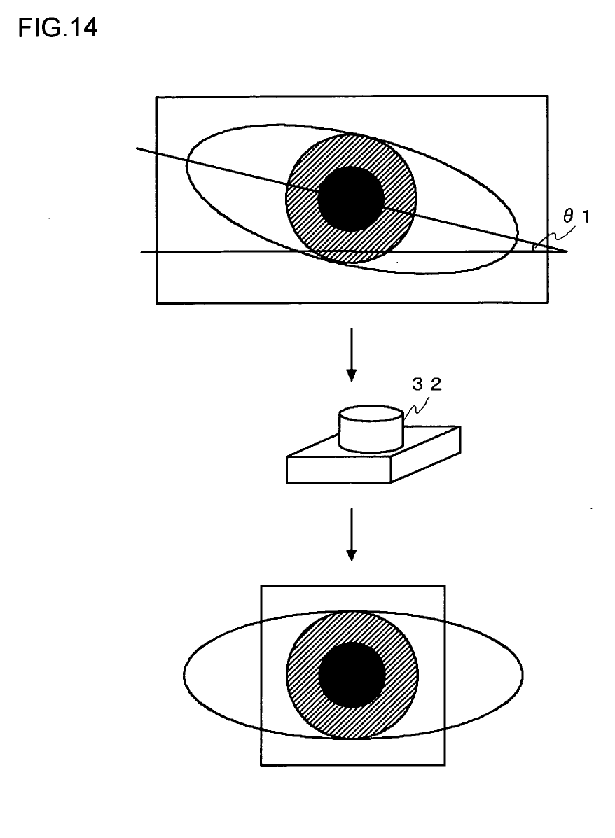

Next, a fourth operation example of authenticating apparatus in the second embodiment is an example where the iris' angle of rotation is fed back to the CCD or the like. FIG. 14 illustrates a process in which the displacement of iris angle is getting corrected. The image processing unit 84 detects the orientation of iris, namely, the orientation in the angle of rotation thereof, from the data on images that contain the iris parts in the image buffer 82. For instance, the iris' angle of rotation can be detected and calculated by detecting an angle θ1 of the corner of an eye. Then the image processing unit 84 feeds back the detected angle to a CCD 32 equipped with a correction function. The CCD 32 equipped with a correction function rotates a captured image by a circuit formed on a CCD substrate in accordance with the fed-back angle of rotation. The CCD with the correction function may rotate itself by an actuator. Furthermore, the angle of rotation may be corrected by an LSI or the like which is provided to correct the direct output from the CCD.

With the provision of such a feedback mechanism as above, images whose orientation is always fixed can be acquired. Templates are then created from the thus acquired images, so that taking into account at the time of matching the relative difference of registered data and matching data will no longer be required. Especially when the division by rows or columns is to be carried out as described above, the rotation directions of iris need to be prepared at the time of authentication. Normally, the correction for these is made at an authenticating part. However, if this correction is made by the CCD or the like, the processing load of the authenticating part can be alleviated.

Next, a fifth operation example of authenticating apparatus in the second embodiment is an example where the opening of pupil is made steadily constant. In the above-described method of processing the image data for each row and column, the correction for the dilation and contraction of iris takes a lot of trouble compared with a method using the division by concentric circles. In contrast thereto, a method for contracting or dilating the pupil of eye is adopted and it is preferable that the state of iris such as the opening of pupil is made steadily constant when the iris images are acquired at the time of registration or authentication.

The light emission unit 70 shown in FIG. 8 irradiates a user's eye with light before or at the time of picking up an iris image so as to contract the pupil. As a result, even when the iris image is shot under different environments, the iris image can be acquired such that the pupil is always in the state of contraction. Hence, the correction for making the size of pupil constant is no longer necessary or can be simplified. For instance, if this scheme is applied to the authentication using a foldable type mobile-phone handset, a control may be such that the light emission unit 70 emits light when a user opens a casing.

According to the second embodiment, the matching is carried out in a manner such that the iris image is divided into rows or columns in lattice shape, so that the processing can be started without waiting for the completion of the output of image data on iris portions from the CCD or the like. That is, the whole of the iris images needs not be stored in working memory, and the minimum necessary working memory is enough to execute the iris authentication. Hence, modules can be made smaller and the authentication apparatus can be produced at low cost.

In contrast thereto, if the iris data are divided concentrically, the whole of the iris images must be recorded so as to process these data. This forces the whole iris images to be stored in the working memory, thereby requiring very large LSI areas. On the other hand, in the image pickup devices such as CCD, the image data are generally acquired, outputted and so forth on a row or column basis, so that the present embodiment is easily achievable using said image pickup devices.

### Third Embodiment

A third embodiment according to the present invention extracts also an image in close proximity of iris at the time of capturing the iris image and makes effective use of such the image. The function block for an authenticating apparatus according to the third embodiment is basically the same as that shown in FIG. 8, so that the repeated explanation therefor is omitted here.

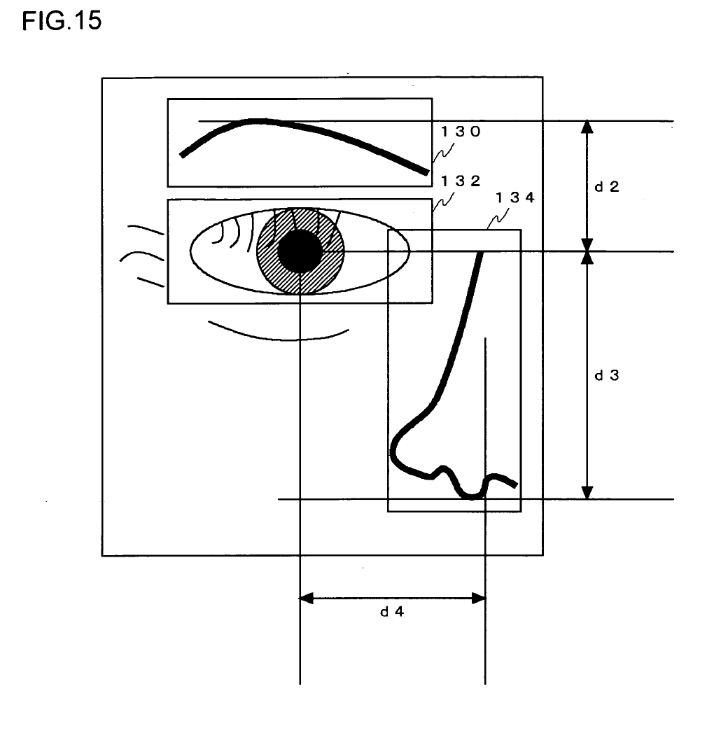

A first operation example of authentication apparatus in the third embodiment is an example where an image of iris is acquired, and simultaneously or subsequently an image in close proximity of the iris is also acquired and the thus acquired information on parts other than the iris is put to use. FIG. 15 shows an image of iris as well as an image near the iris. The image matching unit 86 carries out authentication using the images loaded into the image buffer 82 and the information on parts other than the iris within the image. For instance, a distance d2 between eyebrows and eye, a distance d3 between the center of pupil and the lower edge of nose, a distance d3 between the center of pupil and the center of nose, and/or positional relationships among the respective parts and so forth can be used as the information on parts other than the iris. If these pieces of information are registered beforehand in the image registration unit 88, they can be matched at the time of authentication.

Next, a second operation example of authentication apparatus in the third embodiment is an example where an image of iris is acquired, and simultaneously or subsequently an image in close proximity of the iris is also acquired and the thus acquired information on parts other than the iris is used for living organism detection (life presentation detection) or bioassay. Here, the “living organism detection” is a term used to the effect that not the “artificial or like” iris but the one belonging to “living human” is to be detected. The information used for the living organism detection includes the form of eye, state of cilia, shape of blood vessel in white of the eye ball, shapes of eyebrows, form of nose, form of part of the nose and position of mole within an image that are extracted and loaded into the image buffer 82.

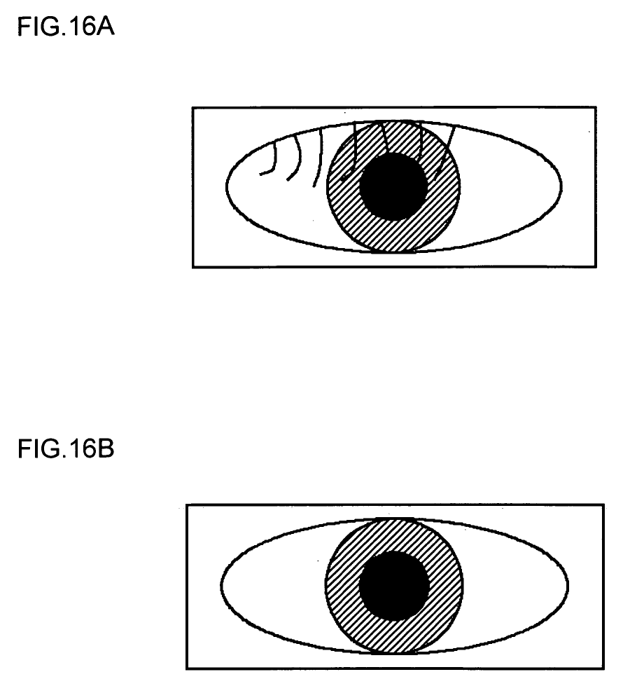

FIGS. 16A and 16B show each an image of the entire eye. FIG. 16A shows an image of eye with cilia whereas FIG. 16B shows an image of eye without cilia. For instance, the image matching unit 86 verifies whether there are cilia or not. Accordingly, if the image acquired is an image similar to FIG. 16B, it can be determined to be nonliving organism since it could be a photograph or the like showing the iris alone. Along with this verification, whether there are eyebrows or not may be verified. Furthermore, whether the pattern of light reflected on the pupil part, which is a black portion positioned inside the iris, coincides with the authentication apparatus in use or not may also be verified. By carrying out these verifying processings as above, the fraudulence caused by forgery or impersonation can be prevented.

Next, a third operation example of authentication apparatus in the third embodiment is an example where the authentication, in which the whole or part of the images in close proximity are used, are used together with the iris authentication in a combined manner. The image matching unit 86 carries out authentication processing by using, in a combined manner, the information obtained from the iris and the information on the form of eye, state of cilia, shape of blood vessel in white of the eye ball, shapes of eyebrows, form of nose, form of part of the nose, position of mole and so forth within an image that are extracted and loaded into the image buffer 82.

For example, both the form of eye and the iris image are subjected to the matching, and the authentication is regarded successful only if both of them coincide with the respective templates. As another example, other than the form of eye may be used. As still another example, the method of using them in a combined manner may be a method other than the above example in which the authentication is regarded successful only if both of them coincide with the respective templates. Furthermore, not only the form of eye but also other parts may be taken into account, so that two or more objects may be combined. For example, as shown in FIG. 15, a combined authentication is carried out using objects such as eyebrow part 130, eye part 132 and nose part 134, and a processing may be such that the authentication is granted if the authentication is successful in every object whereas the authentication is not granted if at least one of the objects does not pass the authentication.

As described above, other pieces of information are extracted together with the iris image and utilized for the authentication, so that the authentication can be easily supplemented to ensure the high accuracy. This feature is very advantageous in that no extra physical cooperation from the user, such as a trouble of holding up his/her finger in front of the image pickup unit 30 for the extraction of fingerprint, is required.

Next, a fourth operation example of authentication apparatus in the third embodiment is an example where data in an iris database are classified using the images in close proximity of iris. The image matching unit 86 classifies the iris image data by using information on the form of eye, state of cilia, shape of blood vessel in white of the eye ball, shapes of eyebrows, form of nose, form of part of the nose and position of mole from images that are extracted and loaded into the image buffer 82.

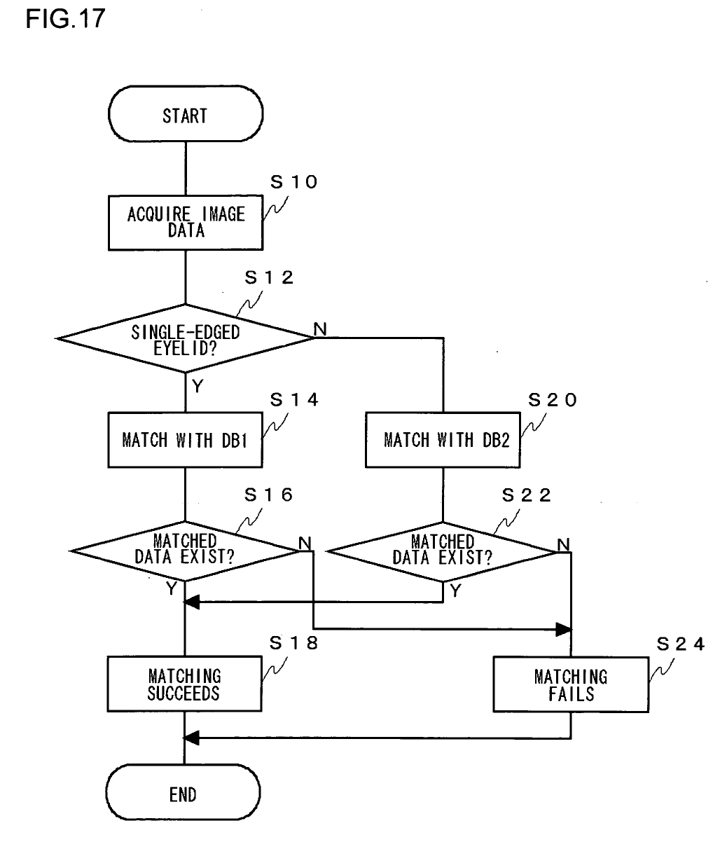

When iris image data are registered, the image registration unit 88 classifies the iris image data based on, for example, whether the eye has a single-edged eyelid or not and then registers them accordingly in advance. FIG. 17 is a flowchart showing an example of matching using a database classified based on whether the eye has a single-edged eyelid or not. The image matching unit 86 acquires the images extracted to the image buffer 82 (S10). Then, whether the eye has a single-edged eyelid or not is determined from the extracted images (S12). If it has the single-edged eyelid (Y of S12), it is matched with a database which registers the iris image data on the single-edged eyelid (S14). If there exists image data that coincide with it (Y of S16), the matching turns out to be successful (S18). If no data that coincide with it exists (N of S16), the matching fails (S24).

In the Step S12, if it is not a database which registered the iris image data on the single-edged eyelid (S14). (N of S12), it is matching with a database which registers the iris image data on other than the single-edged eyelid (S20). If there exists image data that coincide with it (Y of S22), the matching is successful (S18). And if not data that coincide with exists (S of S22), the matching fails (S24).

If the eye that contains the iris which is to be authenticated is found to have the single-edged eyelid, it suffices that the image matching unit 86 carries out matching processing on the registered data only for use with such a category in the database. Hence, the time necessary for the matching processing can be reduced. Although the reduction of matching time is always required in one-to-one matching, the matching is required to be done in a small amount of time especially in the case of carrying out many-to-one matching. For example, if the number of registrants is on the order of 1000 or so in the case of managing to authenticate the entering of people to a building or the like, it takes the enormous time for the entire data to be matched. Therefore, by the use of images in close proximity of iris, the data to be matched can be narrowed down instead of limiting targets by means of ID numbers or the like, thus reducing the matching time. This feature is also very advantageous in that no extra operation on the users' part is required.

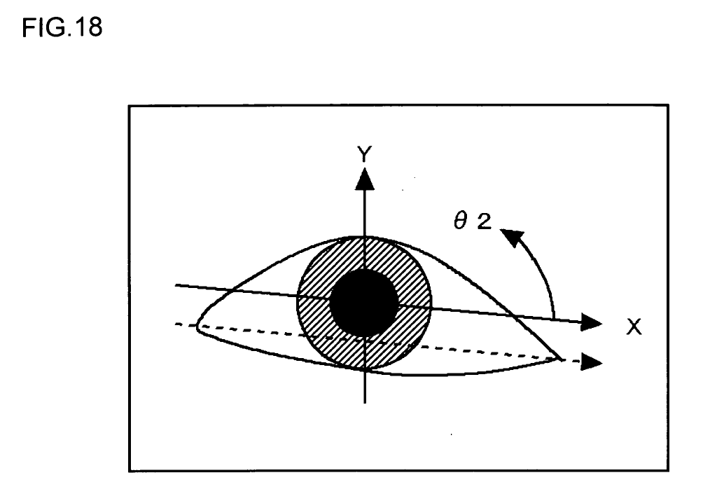

Next, a fifth operation example of authentication apparatus in the third embodiment is an example where the references, such as coordinate axes on the iris and direction serving as a reference, are specified using the images in close proximity of iris. In FIG. 18, a line, which is parallel to a dotted line joining the both ends of an eye and which passes through the center of pupil, is set to an X axis whereas a line, which passes through the center of pupil in the vertical direction, is set to a Y axis. With this X axis set as a reference, an angle of rotation 02 for an iris image extracted at the time of authentication is obtained.

Besides, the image matching unit 86 can specify the position of iris by the use of the positional relationship between the shape of eyelid, state of cilia, shape of blood vessel in white of the eye ball, shapes of eyebrows, form of nose, form of part of the nose, position of mole and the like or a plurality of shapes among any of these and the iris.

According to the fifth operation example, the coordinates serving as the reference at the time of comparing the iris images can be easily made to coincide both at the time of registration and at the authentication, by deciding on the reference using images extracted together with the iris. Thus, this fifth operation example can achieve highly accurate authentication. Since the iris is the annular region of the eye bounded by the black pupil part from the inside thereof and the white part of the eye from the outside thereof, it is of a shape almost symmetric with respect to a point. Thus, it is required that the orientation serving as a reference be aligned for the matching, or the possibility that the irises to be compared are mutually rotated from the beginning needs to be taken into account in the course of authentication. If this is not taken care of or taken into account, a valid individual might be mistakenly judged otherwise. According to this fifth operation, the reference can be easily made to coincide and aligned, so that false mismatch can be prevented.

As described above, according to the third embodiment the images in close proximity of iris are extracted together with the iris and these images in close proximity of iris are actively and explicitly utilized. As a result, the combined authentication, classification of database, proper positioning and so forth can be carried out without causing the user to go through a troublesome extra operation. It is to be noted that capturing an image of both the face and the iris by the use of a single camera requires the very high performance, namely, elements having a very large number of pixels to realize a level of quality endurable against the authentication. However, the image in close proximity of iris can be captured together with the iris with relative ease. For example, when the image of iris is taken by a mobile-phone handset with a camera built therein in a state that the eye does not get into a very close distance to the mobile-phone handset, the entire eye, eyebrows, part of nose, mole and so forth are also naturally shot by the camera. Besides the mobile-phone handsets with built-in cameras, the same is true for the other portable equipment such as PAD (Personal Digital Assistants).

The present invention has been described based on the embodiments which are only exemplary. The present invention is thus not limited by these embodiments, and other various modifications are also effective as the present embodiments. For instance, the above-mentioned portable equipment is not limited to the mobile-phone handset and it includes PDA, PHS (Personal Handyphone System, a compact-size PC (Personal Computer), digital camera and many more.

1. A method of authentication by matching registered iris data with iris data obtained from images picked up at the time of authentication, the method characterized in that a reference position of an iris is determined using a face image and an iris image.

2. A method of authentication by matching registered iris data with iris data obtained from images picked up at the time of authentication, the method characterized in that an iris' angle of rotation from a predetermined reference pattern is identified using a face image and an iris image.

3. A method of authentication according to claim 2, wherein the angle of rotation is identified based on a relative position of a marked-out position on the face image and a marked-out position of the iris image.

4. An authentication apparatus which carries out authentication by matching registered iris data with iris data obtained from images picked up at the time of authentication, the apparatus comprising:
a first image pickup unit which picks up a face image; and
a second image pickup unit which picks up an iris image,
wherein a reference position of an iris is determined using the face image and the iris image.

5. An authentication apparatus which carries out authentication by matching registered iris data with iris data obtained from images picked up at the time of authentication, the apparatus comprising:
a first image pickup unit which picks up a face image; and
a second image pickup unit which picks up an iris image,
wherein an iris' angle of rotation from a predetermined reference pattern is identified using the face image and the iris image.

6. An authentication apparatus according to claim 5, wherein the angle of rotation is identified based on a relative position of a marked-out position on the face image and a marked-out position of the iris image.

7. An authentication apparatus according to claim 4, further comprising a display unit which displays an image inputted from said first image pickup unit and an image inputted from said second image pickup unit in such a manner as to move the iris to a predetermined position on the image inputted from said second image pickup unit.

8. An authentication apparatus according to claim 5, further comprising a display unit which displays an image inputted from said first image pickup unit and an image inputted from said second image pickup unit in such a manner as to move the iris to a predetermined position on the image inputted from said second image pickup unit.

9. An authentication apparatus according to claim 4, further comprising a display unit which displays an image inputted from said first image pickup unit and a predetermined guide in such a manner as to move the iris to a predetermined position on the image inputted from said second image pickup unit.

10. An authentication apparatus according to claim 5, further comprising a display unit which displays an image inputted from said first image pickup unit and a predetermined guide in such a manner as to move the iris to a predetermined position on the image inputted from said second image pickup unit.

11. A portable device equipped with an authentication apparatus which carries out authentication by matching registered iris data with iris data obtained from images picked up at the time of authentication, the authentication apparatus including:
a first image pickup unit which picks up a face image; and
a second image pickup unit which picks up an iris image,
wherein a reference position of an iris is determined using the face image and the iris image.

12. A portable device equipped with an authentication apparatus which carries out authentication by matching registered iris data with iris data obtained from images picked up at the time of authentication, the authentication apparatus including:
a first image pickup unit which picks up a face image; and
a second image pickup unit which picks up an iris image,
wherein an iris' angle of rotation from a predetermined reference pattern is identified using the face image and the iris image.

13. A portable device according to claim 11, wherein said first image pickup unit and said second image pickup unit are mounted on a casing so that a distance between mounting locations of said first image pickup unit and said second image pickup unit is practically maximum.

14. A portable device according to claim 12, wherein said first image pickup unit and said second image pickup unit are mounted on a casing so that a distance between mounting locations of said first image pickup unit and said second image pickup unit is practically maximum.

15. A portable device according to claim 12, wherein the angle of rotation is identified based on a relative position of a marked-out position on the face image and a marked-out position of the iris image.

16. A portable device according to claim 11, wherein said authentication apparatus further includes a display unit which displays an image inputted from said first image pickup unit and an image inputted from said second image pickup unit in such a manner as to move the iris to a predetermined position on the image inputted from said second image pickup unit.

17. A portable device according to claim 12, wherein said authentication apparatus further includes a display unit which displays an image inputted from said first image pickup unit and an image inputted from said second image pickup unit in such a manner as to move the iris to a predetermined position on the image inputted from said second image pickup unit.

18. A portable device according to claim 11, wherein said authentication apparatus further includes a display unit which displays an image inputted from said first image pickup unit and a predetermined guide in such a manner as to move the iris to a predetermined position on the image inputted from said second image pickup unit.

19. A portable device according to claim 12, wherein said authentication apparatus further includes a display unit which displays an image inputted from said first image pickup unit and a predetermined guide in such a manner as to move the iris to a predetermined position on the image inputted from said second image pickup unit.
